(19) United States
(12) Patent Application Publication
(10) Pub. No.: US 2005/0027657 A1
(43) Pub. Date: Feb. 3, 2005

(54) Distinguishing legitimate hardware upgrades from unauthorized installations of software on additional computers

(76) Inventors: Yuri Leontiev, Edmonton (CA); Michele Marik, Edmonton (CA); Joseph A. Smith, St. Albert (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/684,955

(22) Filed: Oct. 13, 2003

Related U.S. Application Data
(63) Continuation-in-part of application No. 10/632,479, filed on Aug. 1, 2003.

(51) Int. Cl. H04K 1/00; H04L 9/00; G06F 17/60

(52) U.S. Cl. 705/59

(57) ABSTRACT

A client transmits requests to access features of a software program to a server. The requests include a hardware profile of the computer on which the user is attempting to run the software. The server stores the hardware profile of the computer on which the user is authorized to run the software program. Responsive to receiving a request, the server determines whether the user is licensed to run the software, by determining whether the received hardware profile is acceptably similar to the stored hardware profile, and/or whether a sufficient period of time has passed since a previous hardware update.

### CROSS-REFERENCE TO RELATED APPLICATIONS

This application is a Continuation-in-Part of U.S. patent application Ser. No. 10/632,479 titled “Dynamic Software License Configuration,” and having a filing date of Aug. 1, 2003.

### BACKGROUND

1. Field of Invention

The present invention relates generally to dynamically configuring user software licenses, and more specifically to using dynamic hardware profiles to distinguish legitimate hardware upgrades from unauthorized installation of software programs on additional computers.

2. Background of Invention

Software piracy is very prevalent, and causes a significant loss of potential revenue for software vendors. For this reason, many software vendors require that a user activate a software license before operating a software program. Typically, the software vendor will provide a unique identifier with each copy of the software. In order to run the software, the user must provide that identifier to the vendor (either via the Internet, by telephone, or some other way). The vendor associates the identifier with the specific user, and stores a record of that association, typically in a database or the like. The vendor then activates the user's copy of the software, either automatically over the Internet, or by providing the user with an activation code to enter manually. Typically, activation involves updating a license file on the user's computer, to indicate that the software is activated. Whenever the software program runs, it checks the license file, and only runs if the software has been activated.

Such a system fails to prevent a user from making unauthorized copies of the software program, once the software program has been activated. Because the activation is performed once, and a record of the activation is kept on the user's computer in the form of the updated (activated) license file, the user can install the software program on a second user's computer, by simply copying the complete contents of the folders that hold the installed software program. Because this will copy the activated license file as well as the software program, the second user will now be able to run the software program. Such unauthorized copying is known is “pass along piracy.”

One method used to prevent pass along piracy is to include a hardware profile of the user's computer in the license file. During the activation process, the software program can scan the hardware of the computer of the authorized user. Then, a profile of the hardware configuration can be stored in the activated license file. When the software program is subsequently run, it can not only check to see if an activated license file is present, but can also check to see if the hardware of the computer it is running on corresponds to that of the authorized user. The software program does this by scanning the hardware of the computer it is running on, and comparing the result to the hardware profile of the authorized user in the license file. Only if the hardware is the same or within an acceptable margin of difference will the software program run. That way, if the user installs an unauthorized copy of the software program on a second user's computer, when the second user tries to run the software program, the software program determines that it is installed on an unauthorized computer and can thereby block unauthorized use.

One problem with such a methodology is that it does not allow an authorized user to upgrade his hardware. For example, if an authorized user changes hardware components of his computer (e.g. changes the monitor, adds a cable modem, adds memory), the current hardware will no longer match the stored hardware profile and the software program will not run. Additionally, the same problem will occur if the authorized user purchases a new computer, and wishes to transfer the software program from the older computer to the new one.

Some software vendors allow a user to call on the telephone and inform the vendor of such changes. If the vendor is convinced that the user really has modified his hardware configuration or purchased a new computer, the vendor can activate the software on the new or modified computer. However, the vendor has no way of knowing whether the user has really made a legitimate hardware modification, or whether the user is attempting to make an unauthorized copy of the software. Suppose that the user has actually engaged in pass along piracy, by installing the software on a second user's computer. If the user convinces the vendor that the new installation is legitimate, the vendor will unknowingly activate the software on the second user's computer. Because the software has already been activated on the first user's computer, nothing stops the first user from continuing to run the software on his computer, while the second user runs the pirated software on a second computer. On the other hand, if the user has legitimately upgraded his computer but cannot convince the vendor, the user will not be able to run the software product at all.

Thus, existing software licensing activation methods either do not adequately prevent pass along piracy, or can prevent an authorized user from running the software product on his own computer, after making legitimate hardware modifications. What is needed are methods, systems and computer readable media for that can detect and prevent pass along piracy, yet allow licensed users to make legitimate hardware modifications to their own computers.

### SUMMARY OF INVENTION

In some embodiments, a user runs a client software program on a computer. As the user runs the software program, the user attempts to access various features of the software program. Requests to access features of the software program are transmitted to a server. Such requests include user identification information and license verification information including a hardware profile of the computer on which the user is attempting to run the software.

The server maintains user software license information, including the hardware profile of the computer on which the user is authorized to run the software program, and the date of the most recent modification of that hardware profile. Responsive to receiving a request, the server retrieves stored license information for the user, and determines whether the received hardware profile is identical or acceptably similar to the stored, authorized hardware profile.

If the received and stored hardware profiles are identical, the server concludes that the user is authorized to run the software, and responds to the request accordingly. If the received profile is acceptably similar to the stored profile but not identical, the server determines whether the difference could be the result of an authorized hardware upgrade. Because legitimate upgrades are only performed with limited frequency, the server compares the current date to the stored date indicating the last authorized modification. If the current date is sufficiently later, the server determines that the user has performed an authorized hardware upgrade. In response, the server updates its stored hardware profile and associated modification date according to the currently detected upgrade, and sends a verification to the client that the user is authorized to run the software program. In some embodiments, if the received hardware profile is acceptably similar to the stored hardware profile but the current date is not sufficiently later than the stored modification date, the server sends an authorization verification to the client, but does not update its stored hardware profile, thereby allowing the user some flexibility while still ensuring a requisite level of security. In other embodiments, the server determines that the user is attempting to run the software on an unlicensed computer, and returns an appropriate indication to the client. If the received hardware profile is neither acceptably similar nor identical to the stored hardware profile, the server determines that the user is attempting to run the software on an unlicensed computer, and returns an appropriate indication to the client.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram providing a high level overview of a system for dynamically managing software license information that includes a hardware configuration identifier and hardware configuration identifier modification date, according to some embodiments of the current invention.

FIG. 2A is a flowchart, illustrating high level steps for processing client requests including hardware configuration identifiers, according to some embodiments of the present invention.

FIG. 2B is a flowchart, illustrating steps for processing client requests where the current date is sufficiently later than the stored hardware configuration identifier modification date, according to some embodiments of the present invention.

FIG. 3 is a flowchart, illustrating steps for processing client requests where the current date is not sufficiently later than the stored hardware configuration identifier modification date, according to some embodiments of the present invention.

FIG. 4 is a flowchart, illustrating steps for server side processing of client requests, where the received hardware configuration identifier and the stored hardware configuration identifier are identical, according to some embodiments of the present invention.

FIG. 5 is a flowchart, illustrating steps for server side processing of client requests, where the received hardware configuration identifier is not acceptably similar or identical to the stored hardware configuration identifier, according to some embodiments of the present invention.

FIG. 6A is a flowchart, illustrating high level steps for client side processing according to some embodiments of the present invention, in which the client makes a supplemental check that the user is licensed to run the software program on the computer on which the program is currently executing.

FIG. 6B is a flowchart, illustrating steps for client side processing where the current date is sufficiently later than the received hardware configuration identifier modification date, according to some embodiments of the present invention.

FIG. 7 is a flowchart, illustrating steps for client side processing where the current date is not sufficiently later than the received hardware configuration identifier modification date, according to some embodiments of the present invention.

FIG. 8 is a flowchart, illustrating steps for client side processing where the received hardware configuration identifier is identical to the current hardware configuration identifier, according to some embodiments of the present invention.

FIG. 9 is a flowchart, illustrating steps for client side processing according to some embodiments of the present invention, where the current hardware configuration identifier created by the client is not acceptably similar or identical to the hardware configuration identifier received from the server.

FIG. 10A is a flowchart, illustrating high level steps for client side processing according to some embodiments of the present invention in which the client performs a validation check upon starting the software program.

FIG. 10B is a flowchart, illustrating steps for client side processing where the current date is sufficiently later than the stored hardware configuration identifier modification date, according to some embodiments of the present invention in which the client performs a validation check upon starting the software program.

FIG. 11 is a flowchart, illustrating steps for client side processing where the current date is not sufficiently later than the stored hardware configuration identifier modification date, according to some embodiments of the present invention in which the client performs a validation check upon starting the software program.

FIG. 12 is a flowchart, illustrating steps for client side processing when the current hardware configuration identifier is identical to the stored hardware configuration identifier, according to some embodiments of the present invention in which the client performs a validation check upon starting the software program.

FIG. 13 is a flowchart, illustrating steps for client side processing when the current hardware configuration identifier is not acceptably similar or identical to the stored hardware configuration identifier, according to some embodiments of the present invention in which the client performs a validation check upon starting the software program.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

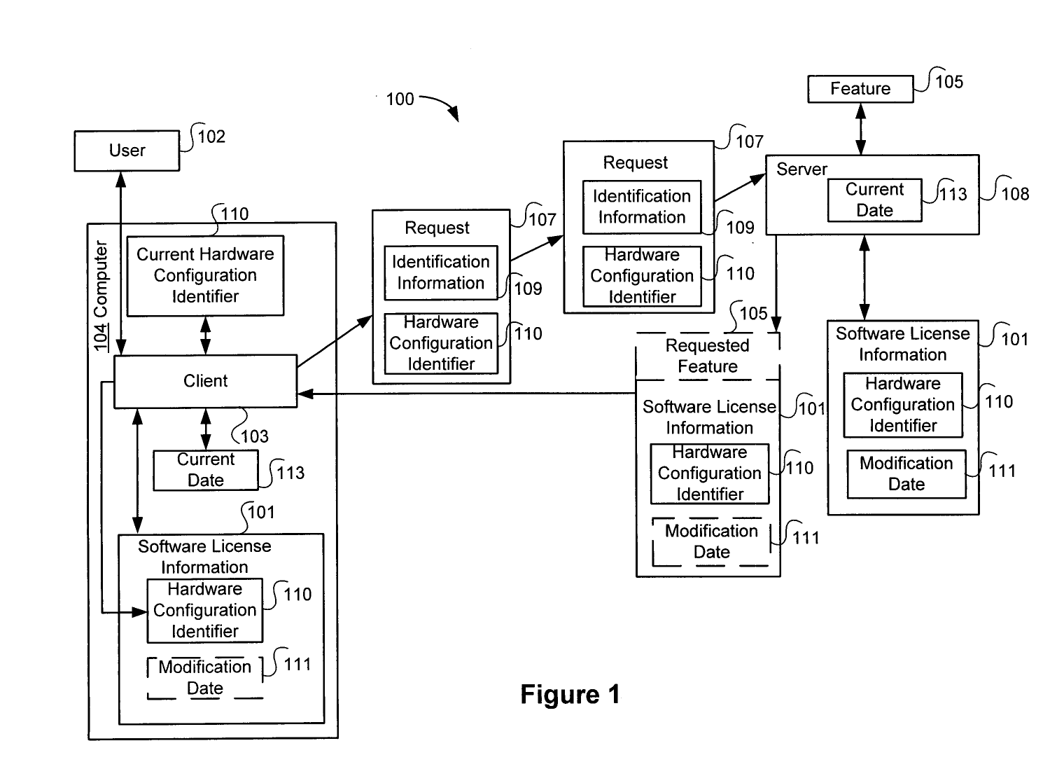

FIG. 1 provides a high level overview of a system 100 for dynamically managing software license information 101 that includes a hardware configuration identifier 110 and a hardware configuration identifier modification date 111, according to some embodiments of the present invention. A user 102 runs a client 103 software program on a computer 104. As the user 102 runs the software program 103, the user 102 attempts to access features 105 of the software program. Some features 105 are provided by a server 108, in which case the client 103 makes requests 107 to the server 108 to access the features 105. Other features are provided locally by the client 103 without the need to access the server 108. In some embodiments of the present invention, the client 103 is configured such that the user 102 attempting to access a client 103 provided feature 105 triggers a request 107 to the server 108, such that the server 108 can dynamically configure the user's software license information 101 as described herein. Which features 105 of the software program result in such a request 107 is a design choice, which can vary from embodiment to embodiment as desired.

Client 103 requests 107 include identification information 109 concerning the user 102, and a hardware configuration identifier 110. The format of the user identification information 109 can vary from embodiment to embodiment. In some embodiments, the user identification information 109 comprises a unique identifier provided by the software vendor with the user's copy of the software. Various formats of user identification information 109 will be readily apparent to one of ordinary skill in the relevant art. The format of the hardware configuration identifier 110 is discussed in greater detail below.

As used herein, the term client 103 simply denotes those aspects of the software program associated with a user's computer 104, as well as underlying operating system and hardware support. As will be understood by those of skill in the art, a client 103 within the context of the present invention can comprise components of the software program, as well as components of the operating system of a user's computer 104 and hardware components of a user's computer 104.

As used herein, the term server 108 simply denotes those aspects of the software program associated with a remote computer, as well as underlying operating system and hardware support. As will be understood by those of skill in the art, a server 108 within the context of the present invention can comprise components of the software program, as well as components of the operating system of a remote computer 104 and hardware components of a remote computer 104.

The server 108 receives requests 107 from the client 103 to access features 105 of the software program. Although FIG. 1 illustrates two requests 107 being transmitted by a client 103 to a server 108, the number two is of course only an example. One of ordinary skill in the relevant art will readily understand that over a period of time, the client 103 can make a variable number of requests 107 as desired.

Responsive to receiving a request 107, the server 108 retrieves stored software license information 101 concerning the user 102. The server 108 can utilize the user identification information 109 to locate the stored software license information 101 in a manner that will be readily apparent to one of ordinary skill in the relevant art, in light of this specification.

In the embodiments illustrated in FIG. 1, the client 103 includes a current hardware configuration identifier 110 with each request. Using techniques that will be readily apparent to one of ordinary skill in the art, the client 103 can create a hardware configuration identifier 110 that corresponds to the hardware configuration of the user's computer 104. The hardware configuration identifier 110 need not be a detailed listing of the complete hardware configuration of the user's computer 104, but contains information representing a sufficient number of hardware components to identify a computer 104 by its hardware configuration. One of ordinary skill in the relevant art will readily understand that various formats are possible for the hardware configuration identifier 110, for example a hash of selected components. The selection and number of components to include, as well as the format, are design choices.

The stored license information 101 on the server 108 includes a hardware configuration identifier 110 concerning the user's computer 104, as well as an associated hardware configuration identifier modification date 111. In some embodiments, the user's hardware configuration identifier 110 is stored by the server when the user's software license is first activated. Initially, the modification date 111 is set to the current date 113 at the time the user's software license is initially activated. Subsequently, the stored hardware configuration identifier 110 can be updated, as explained below. When the stored hardware configuration identifier 110 is modified, the associated modification date 111 is updated as well, to reflect the date of the modification.

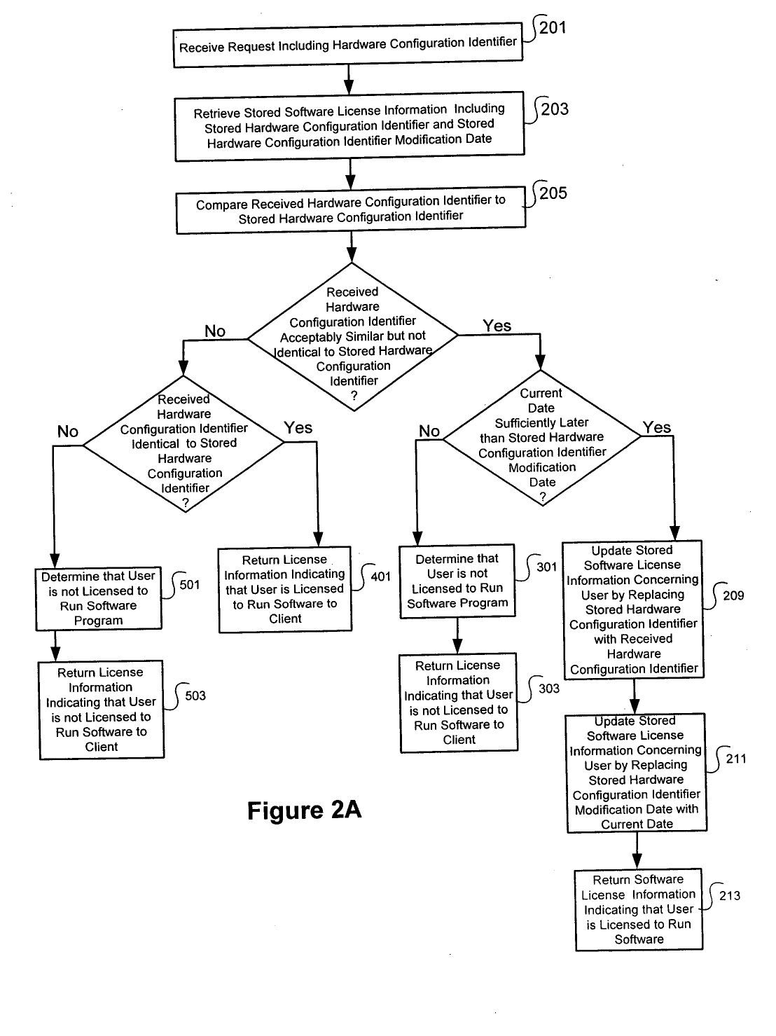

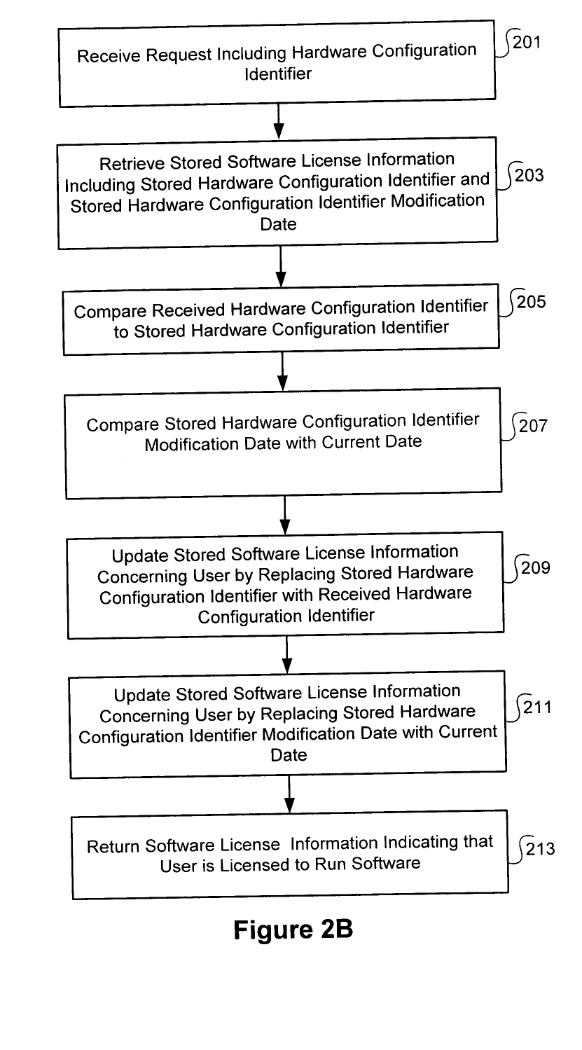

FIG. 2A illustrates high level steps for processing client 103 requests 107 including hardware configuration identifiers 110, according to some embodiments of the present invention. The steps illustrated at a high level in FIG. 2A are described in detail in conjunction with FIGS. 2B through 5.

FIG. 2B illustrates steps for processing client 103 requests 107 where the current date 113 is sufficiently later than the stored hardware configuration identifier modification date 111 according to some embodiments of the present invention. When the server 108 receives 201 a request 107, the server 108 retrieves 203 stored license information 101 concerning the user 102, the stored license information 101 including a hardware configuration identifier 110 concerning the user's computer 104 and an associated modification date 111. The server 108 then compares 205 the received hardware configuration identifier 110 to the stored hardware configuration identifier 110, to determine whether the received hardware configuration identifier 110 is acceptably similar to the stored hardware configuration identifier 110. Recall that when the user's software license was activated, the server 108 stored what was at that time a current identifier 110 of the hardware configuration of the user's computer 104. The received request 107 includes an identifier 110 of the hardware configuration of the user's computer 104 at the time the request 107 was transmitted. By comparing 205 the stored hardware configuration identifier 110 to the received hardware configuration identifier 110, the server can determine whether or not the software program is being run on a licensed computer 104.

It is to be understood that the definition of “acceptably similar” is a design choice, which is a function of to what extent hardware modifications will be permitted without triggering a determination of a new computer 104. In different embodiments varying amounts of difference are tolerated, as desired. For example, in some embodiments a specific number of hardware components must be identical for the two identifiers 110 to be considered acceptably similar.

If the received hardware configuration identifier 110 is acceptably similar but not identical to the stored hardware configuration identifier 110, the server 108 compares 207 the stored modification date 111 with the current date 113. Because the received hardware configuration identifier 110 is not identical to the stored hardware configuration identifier 110, the server 108 has detected that the user's 102 hardware profile has been updated. The received hardware configuration identifier 110 is acceptably similar to the stored hardware configuration identifier 110, indicating a hardware upgrade by the user 102, as opposed to installation of the software on a new computer 104. Nonetheless, it is desirable for the server 108 to determine how long it has been since the user's 102 last hardware upgrade. This is because even acceptable hardware upgrades are only permitted every so often. If users 102 were allowed to make an unlimited number of hardware upgrades at an unrestricted frequency, users 102 could move software from computer to computer by moving hardware components between computers 104 in succession, generating online requests 107 after each reconfiguration.

Thus, the server 108 only concludes that the request was generated from a licensed computer 104 if the current date 113 is sufficiently later than the stored hardware configuration identifier modification date 111. In this case, the server 108 updates 209, 211 the stored software license information 101 concerning the user 102 by replacing the stored hardware configuration identifier 110 with the received hardware configuration identifier 110, and by replacing the stored hardware configuration identifier modification date 111 with the current date 113. Thus, the server has recorded the current hardware profile of the user's 102 computer, along with the date that the server 108 detected the hardware upgrade. This information can be used by the server for subsequent user 102 license verification. The server 108 returns 213 software license information 101 concerning the user to the client 103, indicating that the user 102 is licensed to run the software. This license information includes the updated stored hardware configuration identifier 110 and, in some embodiments, its associated modification date 111. This information can be used by the client 103 for additional verification, as discussed below.

It is to be understood that the definition of “sufficiently later” is a design choice, which is a function of how often modifications will be permitted without triggering a determination of a new computer 104. In different embodiments, various modification frequencies are tolerated, as desired.

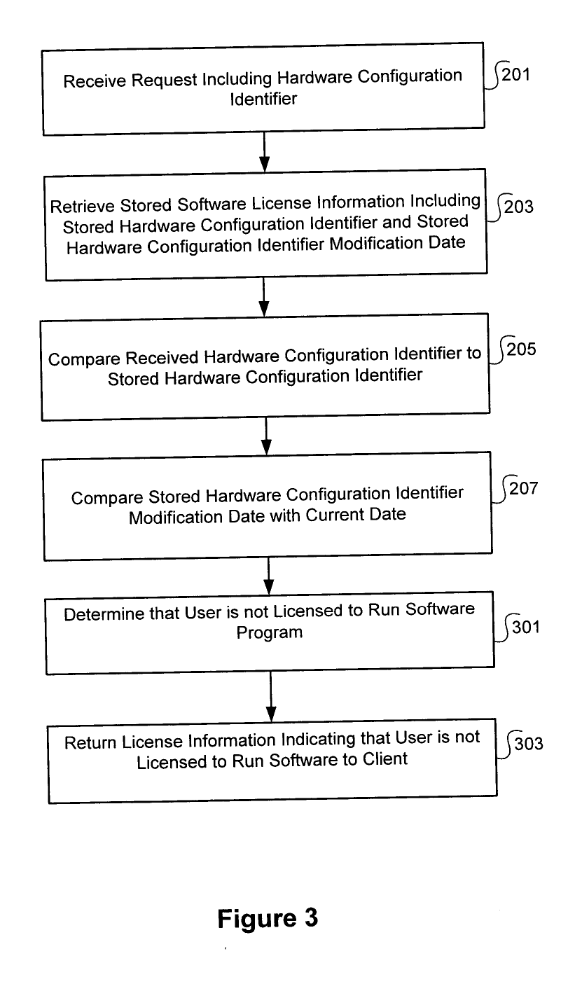

FIG. 3 illustrates steps for processing client 103 requests 108 where the current date 113 is not sufficiently later than the stored hardware configuration identifier modification date 111, according to some embodiments of the present invention. As explained above in conjunction with FIG. 2B, the server 108 receives 201 a request 108, retrieves 203 stored license information 101 concerning the user 102 and compares 205 the received hardware configuration identifier 110 to the stored one 110. Responsive to the received hardware configuration identifier 110 being acceptably similar but not identical to the stored hardware configuration identifier 110, the server 108 compares 207 the stored modification date 111 with the current date 113. Where the current date 113 is not sufficiently later than the stored hardware configuration identifier modification date 111, in some embodiments the server 108 determines 301 that the user is not licensed to run the software program, and therefore returns 303 software license information 101 so indicating to the client 103 (as illustrated in FIGS. 2A and 3). In other embodiments, the server 108 sends license information 101 to the client 103 allowing the user 102 to run the software, but the server 108 does not update the stored software license information 101 concerning the user 102 by replacing the stored hardware configuration identifier 110 with the received hardware configuration identifier 110, or by replacing the stored hardware configuration identifier modification date 111 with the current date 113 (not illustrated). Such embodiments allow the user 102 some flexibility while still ensuring a requisite level of security.

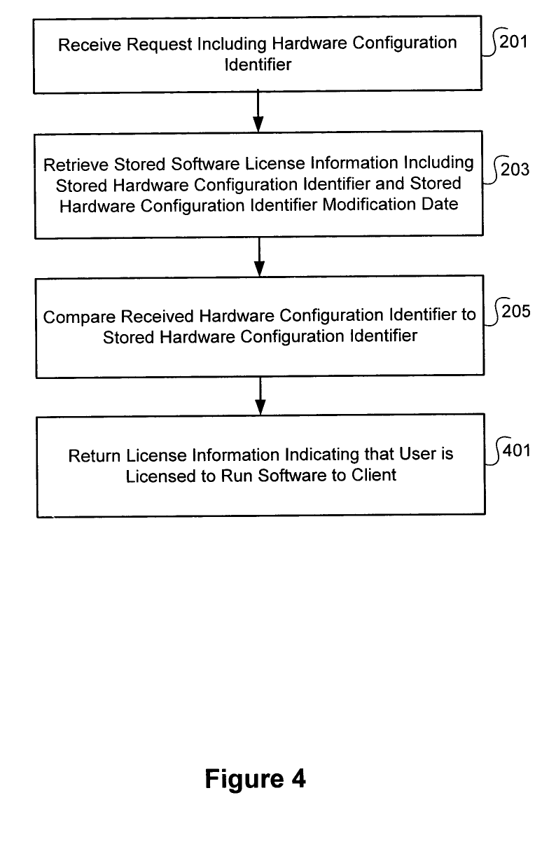

Sometimes, the received hardware configuration identifier 110 and the stored hardware configuration identifier 110 will be identical. FIG. 4 illustrates steps for server 108 side processing of client 103 requests 108 under those circumstances, according to some embodiments of the present invention. The server 108 receives 201 a request 108, retrieves 203 stored license information 101 concerning the user 102 and compares 205 the received hardware configuration identifier 110 to the stored identifier 110. Responsive to the received hardware configuration identifier 110 being identical to the stored hardware configuration identifier 110, the server 108 returns 401 license information 101 indicating that the user 102 is licensed to run the software. Because the hardware configuration identifier 110 received with the request 108 is identical to the one stored by the server 108, the server 108 is able to conclude that the request 108 originated from a licensed computer 104.

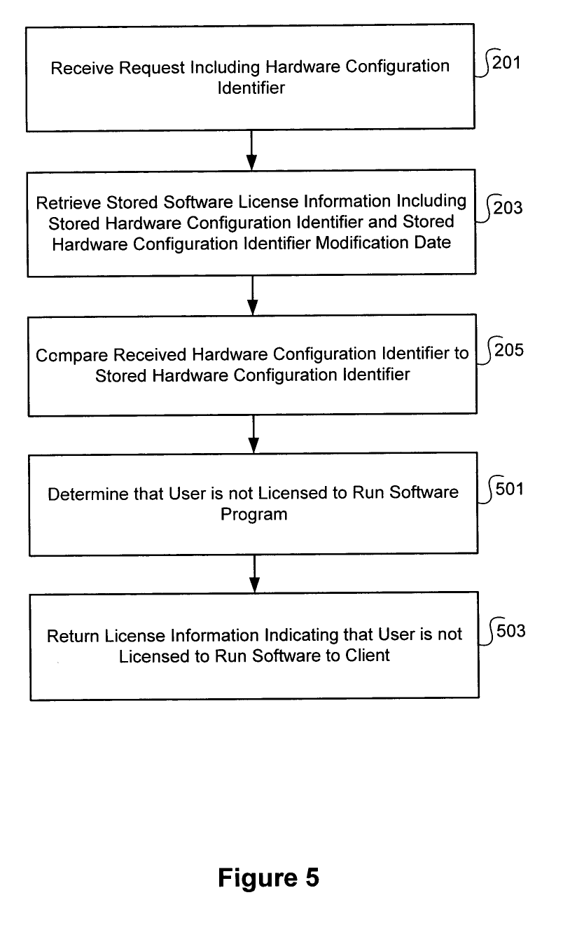

Of course, sometimes the received hardware configuration identifier 110 is not acceptably similar or identical to the stored hardware configuration identifier 110. Steps for processing requests 108 under such scenarios according to some embodiments of the present invention are illustrated by FIG. 5. The server 108 receives 201 a request 108, retrieves 203 stored license information 101 concerning the user 102 and compares 205 the received hardware configuration identifier 110 to the stored identifier 110. Responsive to received hardware configuration identifier 110 neither being acceptably similar nor identical to the stored hardware configuration identifier 110, the server 108 determines 501 that the user is not licensed to run the software program, and returns 503 software license information 101 so indicating to the client 103.

Returning to FIG. 1, note that in one embodiment, whether the user 102 is or is not licensed to run the software program, the server 108 returns software license information 101 concerning the user 102 to the client 103. Where the server 108 determines that the user 102 is licensed to access a requested server 108 provided feature 105 of the software program, the server 108 provides the requested feature 105 of the software program to the client 103. Where the server 108 determines that the user 102 is not licensed to access a requested feature 105 of the software program, the server 108 does not provide the requested feature 105 of the software program to the client 103. The client 103 can respond accordingly in various ways as desired, for example by not allowing the user 102 to run the software program. Client 103 side processing is discussed in greater detail below.

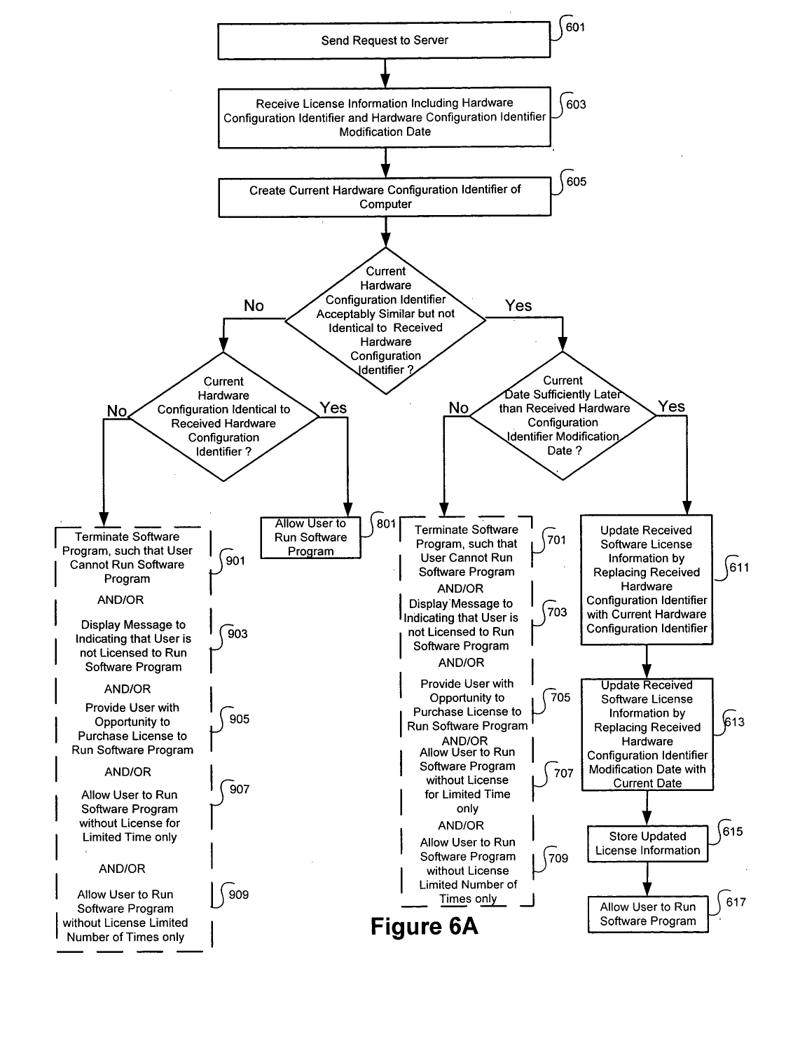

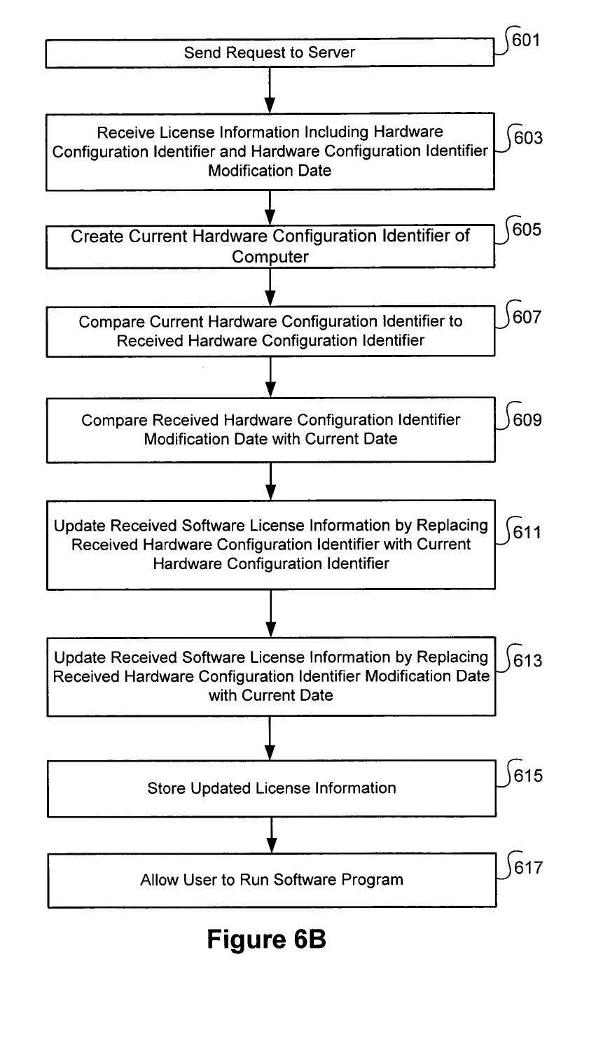

Turning to FIG. 6A, this specification will now explain client 103 side processing according to some embodiments of the present invention, in which the client 103 makes a supplemental check that the user 102 is licensed to run the software program on the computer 104 on which the program is currently executing (it is to be understood that not all embodiments of the present invention make such supplemental checks). FIG. 6A illustrates high level steps for client 103 side processing according to some such embodiments of the present invention. The steps illustrated at a high level in FIG. 6A are described in detail in conjunction with FIGS. 6B through 9.

FIG. 6B illustrates steps for client 103 side processing where the current date 113 is sufficiently later than the received hardware configuration identifier modification date 111, according to some embodiments of the present invention. The client 108 sends 601 requests 107 to a server 108 to access features 105 of a software program, as explained above. In response to a request 107, the client receives 603 current user software license information 101 from the server 108. If the server 108 determines that the user 102 is licensed to run the software program, the license information 101 includes a hardware configuration identifier 110 and, in some embodiments, its associated modification date 111. Recall that the hardware configuration identifier 110 returned by the server 108 maps to the hardware profile of the computer 104 on which the server 108 has most recently determined that the user 102 is authorized to run the software program, and that the associated hardware configuration identifier modification date 111 maps to the date on which the server 108 detected that the hardware profile of that computer 104 had been most recently modified. When the server 108 determines that the user 102 is licensed to access the requested feature 105, the server 108 returns the requested feature 105 as well, where the feature 105 in question is one provided by the server 108 (as illustrated in FIG. 1).

When the client receives 603 software license information 101 including a hardware configuration identifier 110 from the server 108, the client 103 proceeds to use techniques that will be readily apparent to one of ordinary skill in the art to determine the current hardware configuration of the user's 102 computer 104, and to create 605 a corresponding current hardware configuration identifier 110. The client 103 compares 607 the current hardware configuration identifier 110 to the received hardware configuration identifier 110, in order to determine whether the two hardware configuration identifiers 110 are acceptably similar. In some embodiments, where the current hardware configuration identifier 110 is acceptably similar but not identical to the received hardware configuration identifier 110, the client compares 609 the received hardware configuration identifier modification date 111 with the current date 113 (which can be supplied by the server 108 for security purposes), in order to determine whether the current date 113 is sufficiently later than the received hardware configuration identifier modification date 111. If the current date 113 is sufficiently later than the received hardware configuration identifier modification date 111, the client determines that the detected hardware modification to the computer 104 is legitimate, because the hardware profile is still acceptably similar, and the modification occurred an acceptable amount of time after the previous modification. In this case, the client updates 611, 613 the received software license information 101 concerning the user 102 by replacing the received hardware configuration identifier 110 with the current hardware configuration identifier 110, and by replacing the received hardware configuration identifier modification date 111 with the current date 113. The client then stores 615 the updated license information 101 (as illustrated in FIG. 1), for use in subsequent verifications as desired. The client proceeds to allow 617 the user 102 to run the software program.

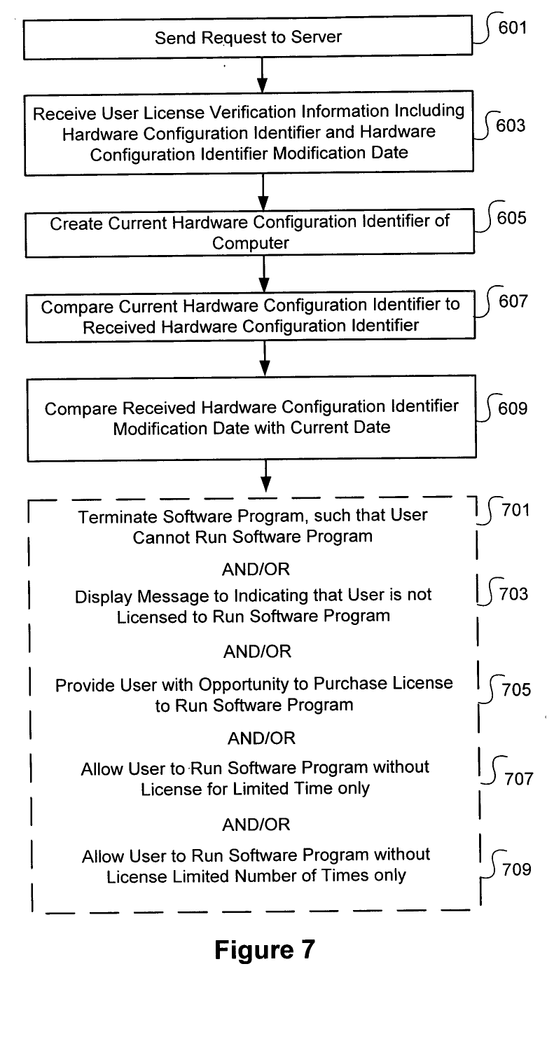

Of course, sometimes the current date 113 will not be sufficiently later than the received hardware configuration identifier modification date 111. Client 103 side processing under those circumstances according to some embodiments of the present invention is illustrated in FIG. 7. As described above in conjunction with FIG. 6B, the client 108 sends 601 requests 107 to the server 108 to access features 105 of a software program. In response to a request 107, the client receives 603 current user software license information 101 from the server 108. When the client receives 603 software license information 101 including a hardware configuration identifier 110 from the server 108, the client 103 proceeds to create 605 a current hardware configuration identifier 110 pertaining to the user's 102 computer 104. The client 103 compares 607 the current hardware configuration identifier 110 to the received hardware configuration identifier 110, in order to determine whether the two hardware configuration identifiers 110 are acceptably similar. Where the current hardware configuration identifier 110 is acceptably similar but not identical to the received hardware configuration identifier 110, in some embodiments the client compares 609 the received hardware configuration identifier modification date 111 with the current date 113. If the current date 113 is not sufficiently later than the received hardware configuration identifier modification date 111, in some embodiments the client 103 determines that the user 102 is not authorized to run the software program, as illustrated in FIGS. 6A and 7. In response, in some embodiments the client 103 responds by terminating 701 the software program, such that the user 102 cannot run the software program. In other embodiments, the client 103 responds in other ways as desired. For example, the client 103 can display 703 a message to the user 102 indicating that the user is not licensed to run the software program. The client 103 can provide 705 the user 102 with an opportunity to purchase a license, for example by entering credit card information. The client 103 can allow 707 a certain number of unlicensed grace uses, or allow 709 unlicensed use for a specific period of time. As will be apparent to one of ordinary skill in the relevant art, various possible client 103 responses to detected unlicensed use of the software program are possible, all of which are within the scope of the present invention. In other embodiments, the client allows 617 the user 102 to run the software program, but does not update 611, 613 the received software license information 101 concerning the user 102 by replacing the received hardware configuration identifier 110 with the current hardware configuration identifier 110, or by replacing the received hardware configuration identifier modification date 111 with the current date 113 (not illustrated). Such embodiments allow the user 102 some flexibility while still ensuring a requisite level of security.

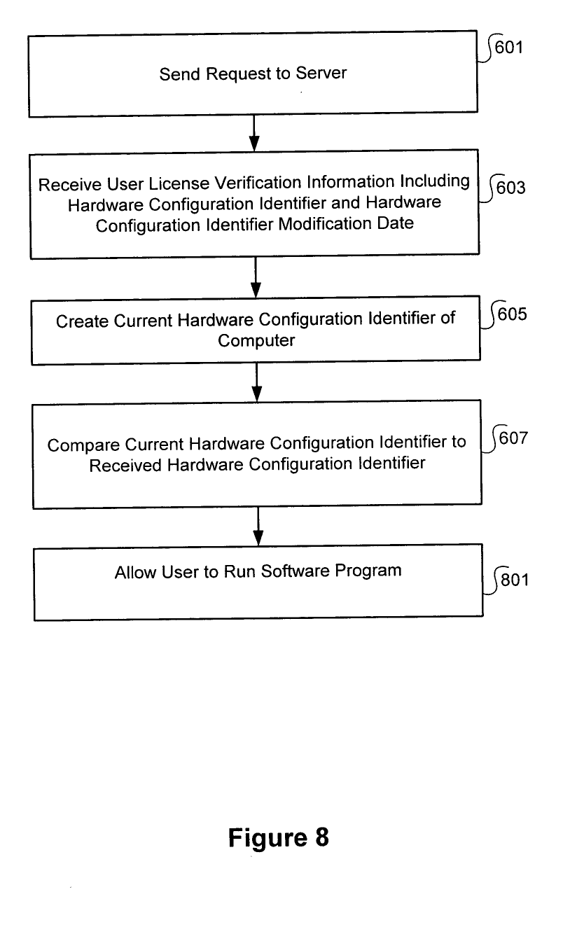

Sometimes the client 103 will determine that the received hardware configuration identifier 110 is identical to the current hardware configuration identifier 110. Steps for client side processing in these cases according to some embodiments of the present invention are illustrated by FIG. 8. As describe above, the client 108 sends 601 requests 107 to the server 108. In response to a request 107, the client receives 603 current user software license information 101 from the server 108 including a hardware configuration identifier 110. The client 103 proceeds to create 605 a current hardware configuration identifier 110 pertaining to the user's 102 computer 104. The client 103 compares 607 the current hardware configuration identifier 110 to the received hardware configuration identifier 110, and determines that the two identifiers 110 are identical. In response, the client 103 determines that the user is licensed to run the software program, and allows 801 the user to do so.

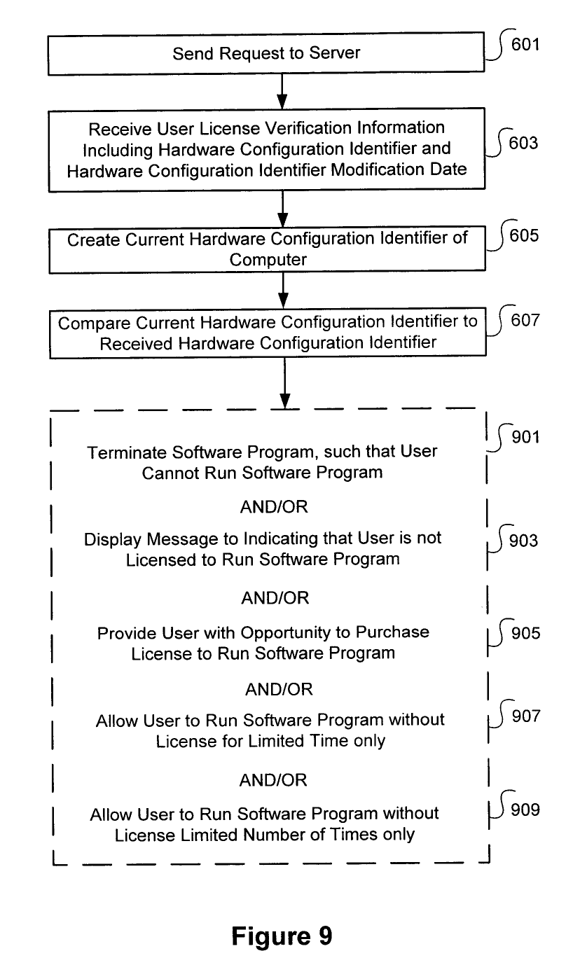

FIG. 9 illustrates steps for client 103 side processing according to some embodiments of the present invention, when the current hardware configuration identifier 110 created 605 by the client 103 is not acceptably similar or identical to the hardware configuration identifier 110 received 603 from the server. The client 108 sends 601 requests 107 to the server 108 to access features 105 of a software program. In response to a request 107, the client receives 603 current user software license information 101 including a hardware configuration identifier 110 from the server 108. The client 103 proceeds to create 605 a current hardware configuration identifier 110 pertaining to the user's 102 computer 104. The client 103 compares 607 the current hardware configuration identifier 110 to the received hardware configuration identifier 110, and determines that the current hardware configuration identifier 110 is not acceptably similar or identical to the received hardware configuration identifier 110. In response, in some embodiments the client 103 responds by terminating 901 the software program, such that the user 102 cannot run the software program. In other embodiments, the client 103 responds in other ways as desired. For example, the client 103 can display 903 a message to the user 102 indicating that the user is not licensed to run the software program. The client 103 can provide 905 the user 102 with an opportunity to purchase a license, for example by entering credit card information. The client 103 can allow 907 a certain number of unlicensed grace uses, or allow 909 unlicensed use for a specific period of time. Of course, in other embodiments the client 103 can respond in other ways, as desired.

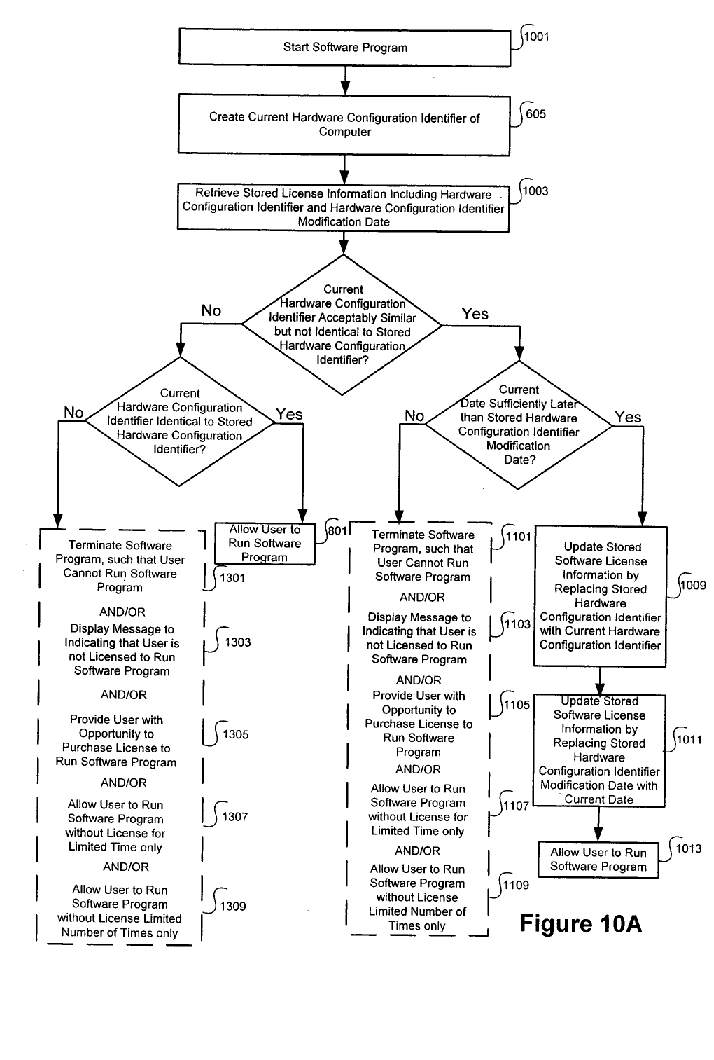

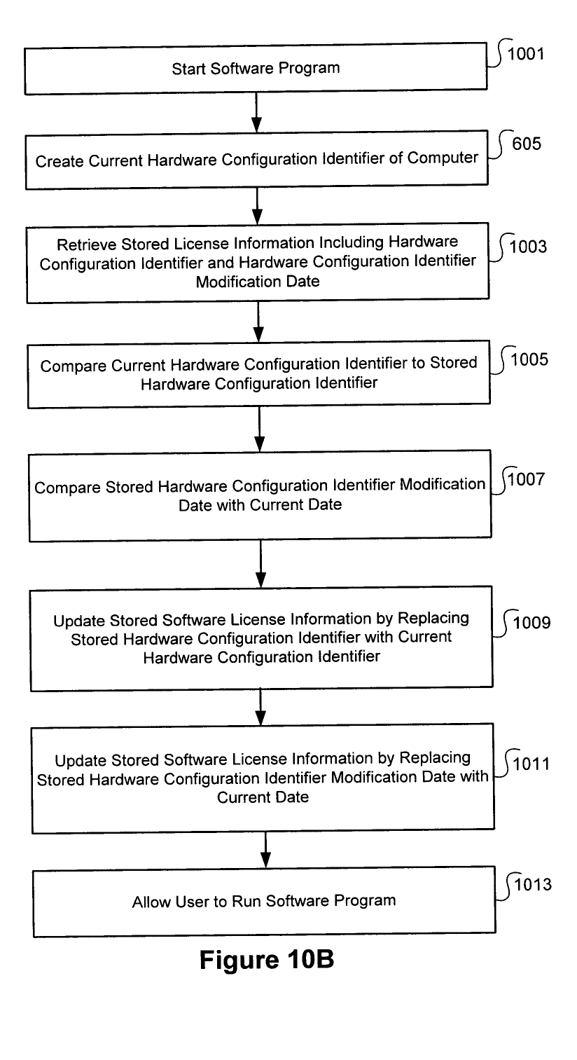

In some embodiments, the client 103 performs a validation check upon starting the software program. It is to be understood that some embodiments of the present invention do not perform such a validation check. In one embodiment, the client 103 makes such a check every time the software program is started, whereas in other embodiments such checks are made less than every time, for example according to a specific frequency, randomly or according to some other methodology. FIG. 10A illustrates high level steps for a client 103 performing such a validation check, according to some embodiments of the present invention. The steps illustrated at a high level in FIG. 10A are described in detail in conjunction with FIGS. 10B through 13.

FIG. 10B illustrates steps for client 103 side processing where the current date 113 is sufficiently later than the stored hardware configuration identifier modification date 111, according to some embodiments of the present invention in which the client 103 performs a validation check upon starting the software program. The client 103 starts 1001 the software program, and creates 605 a current hardware configuration identifier 110 pertaining to the user's 102 computer 104. In order to verify that the user 102 is authorized to run the software program on the computer 104, the client 103 retrieves 1003 stored software license information 101 concerning the user 102, the license information 101 including a hardware configuration identifier 110 of the user's 102 computer 104 and an associated hardware configuration identifier modification date 111. Such stored information 101 can be created when the software program is first installed on the computer 104 and the user's 102 license initially verified. As explained above in conjunction with FIG. 6B, the stored license information 101 can be updated as permissible hardware updates are detected and verified.

The client compares 1005 the current hardware configuration identifier 110 to the retrieved, stored hardware configuration identifier 110, to determine whether the two are acceptably similar. Responsive to the current hardware configuration identifier 110 being acceptably similar but not identical to the stored hardware configuration identifier 110, in some embodiments the client compares 1007 the stored hardware configuration identifier modification date 111 with the current date 113, which can be supplied by the server 108. Responsive to the current date 113 being sufficiently later than the stored hardware configuration identifier modification date 111, the client 103 updates 1009, 1011 the stored software license information 101 concerning the user 102 by replacing the stored hardware configuration identifier 110 with the current hardware configuration identifier 110, and replacing the stored hardware configuration identifier modification date 111 with the current date 113. Responsive to the current date 113 being sufficiently later than the stored hardware configuration identifier modification date 111, the client 103 proceeds to allow 1013 the user 102 to run the software program.

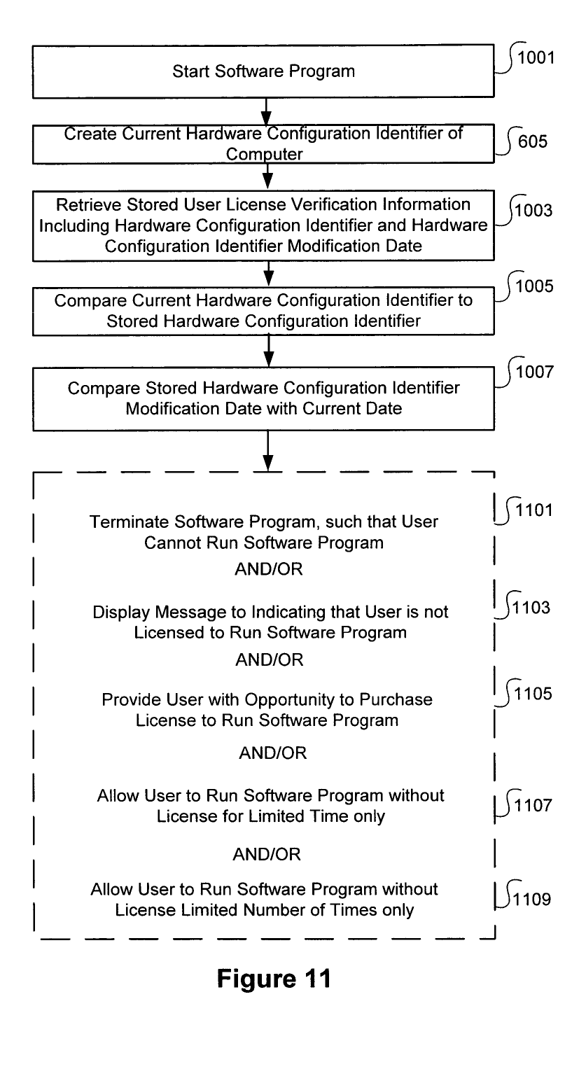

FIGS. 11-13 illustrate client 103 side processing according to some embodiments in which the client 103 performs a validation check upon starting the software program under other circumstances. FIG. 11 illustrates steps for such processing when the current date 113 is not sufficiently later than the stored hardware configuration identifier modification date 111. As explained above in conjunction with FIG. 10B, the client 103 starts 1001 the software program, and creates 605 a current hardware configuration identifier 110 pertaining to the user's 102 computer 104. In order to verify that the user 102 is authorized to run the software program on the computer 104, the client 103 retrieves 1003 stored software license information 101 concerning the user 102, the license information 101 including a hardware configuration identifier 110 of the user's 102 computer 104 and an associated hardware configuration identifier modification date 111. The client compares 1005 the current hardware configuration identifier 110 to the retrieved, stored hardware configuration identifier 110, to determine whether the two are acceptably similar. Responsive to the current hardware configuration identifier 110 being acceptably similar but not identical to the stored hardware configuration identifier 110, in some embodiments the client compares 1007 the stored hardware configuration identifier modification date 111 with the current date 113, which can be supplied by the server 108 as described above. As illustrated by FIGS. 10A and 11, responsive to the current date 113 not being sufficiently later than the stored hardware configuration identifier modification date 111, in some embodiments the client 103 responds by terminating 1101 the software program, such that the user 102 cannot run the software program. In other embodiments, the client 103 responds in other ways as desired. For example, the client 103 can display 1103 a message to the user 102 indicating that the user is not licensed to run the software program. The client 103 can provide 1105 the user 102 with an opportunity to purchase a license, for example by entering credit card information. The client 103 can allow 1107 a certain number of unlicensed grace uses, or allow 1109 unlicensed use for a specific period of time. As explained above, various possible client 103 responses to detected unlicensed use of the software program are possible, all of which are within the scope of the present invention. In other embodiments, the client allows 1013 the user 102 to run the software program, but does not update 1009, 1011 the stored software license information 101 concerning the user 102 by replacing the stored hardware configuration identifier 110 with the current hardware configuration identifier 110, or by replacing the stored hardware configuration identifier modification date 111 with the current date 113 (not illustrated). Such embodiments allow the user 102 some flexibility while still ensuring a requisite level of security.

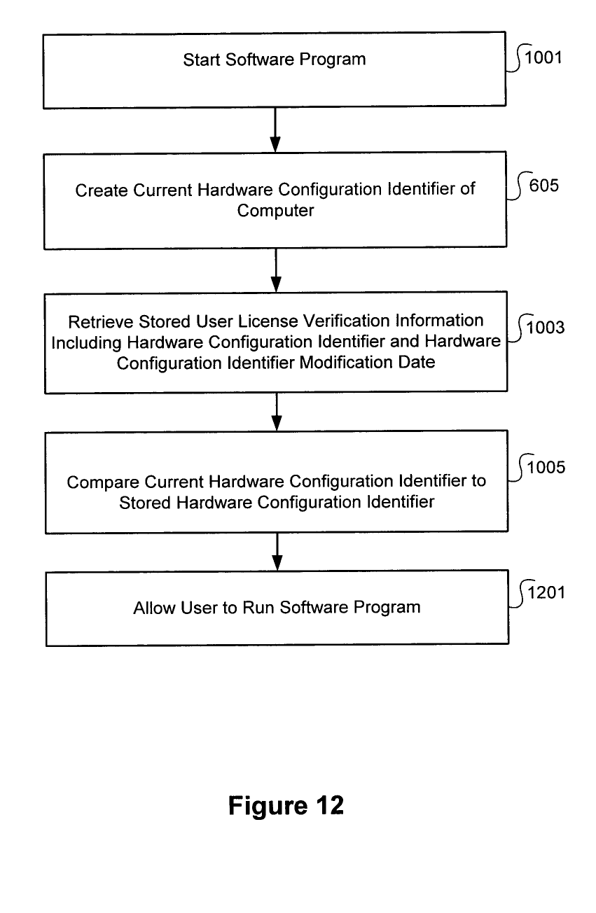

FIG. 12 illustrates steps for client 103 side processing when the current hardware configuration identifier 110 is identical to the stored hardware configuration identifier 110, according to some embodiments of the present invention in which the client 103 performs a validation check upon starting the software program. As explained above, the client 103 starts 1001 the software program, and creates 605 a current hardware configuration identifier 110 pertaining to the user's 102 computer 104. In order to verify that the user 102 is authorized to run the software program on the computer 104, the client 103 retrieves 1003 stored software license information 101 including a hardware configuration identifier 110 of the user's 102 computer 104. The client compares 1005 the current hardware configuration identifier 110 to the stored hardware configuration identifier 110, and determines that the current hardware configuration identifier 110 is identical to the stored hardware configuration identifier 110. Responsive to the current hardware configuration identifier 110 being identical to the stored hardware configuration identifier 110, the client 103 allows 1201 the user 102 to run the software program.

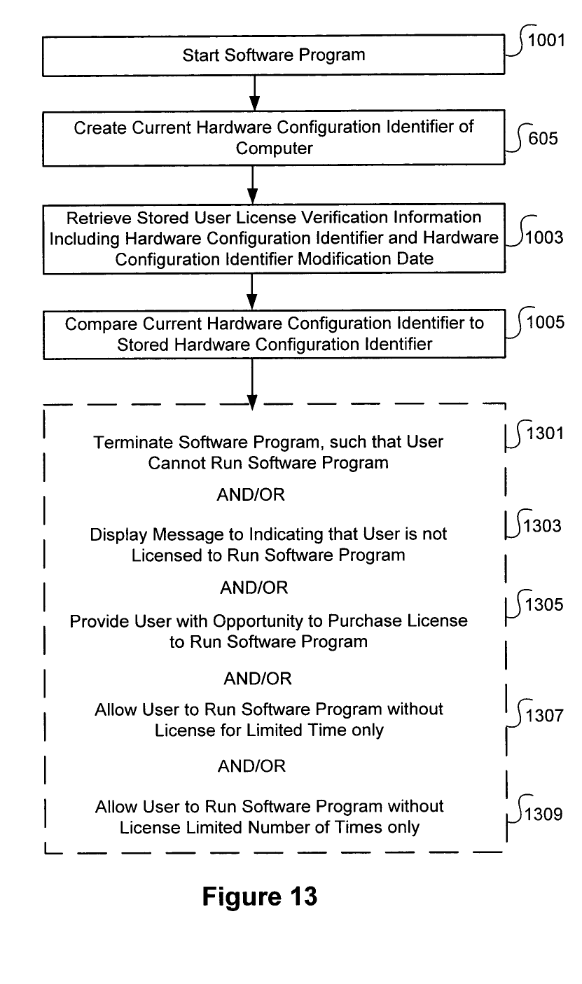

FIG. 13 illustrates steps for client 103 side processing when the current hardware configuration identifier 110 is not acceptably similar or identical to the stored hardware configuration identifier 110, according to some embodiments of the present invention in which the client 103 performs a validation check upon starting the software program. The client 103 starts 1001 the software program, and creates 605 a current hardware configuration identifier 110 pertaining to the user's 102 computer 104. The client 103 retrieves 1003 stored software license information 101 including a hardware configuration identifier 110 of the user's 102 computer 104, and compares 1005 the current hardware configuration identifier 110 to the stored hardware configuration identifier 110. The client 103 determines that the current hardware configuration identifier 110 is neither acceptably similar nor identical to the stored hardware configuration identifier 110. In response to the current hardware configuration identifier 110 not being acceptably similar to the stored hardware configuration identifier 110 and not being identical to the stored hardware configuration identifier 110, in some embodiments the client 103 terminates 1301 the software program, such that the user 102 cannot run the software program. In other embodiments, the client 103 responds in other ways as desired. For example, the client 103 can display 1303 a message to the user 102 indicating that the user is not licensed to run the software program. The client 103 can provide 1305 the user 102 with an opportunity to purchase a license, for example by entering credit card information. The client 103 can allow 1307 a certain number of unlicensed grace uses, or allow 1309 unlicensed use for a specific period of time. In other embodiments the client 103 can respond in other ways, as desired.

As will be understood by those familiar with the art, the invention may be embodied in other specific forms without departing from the spirit or essential characteristics thereof. Likewise, the particular naming and division of the modules, features, attributes, methodologies, clients, servers and other aspects are not mandatory or significant, and the mechanisms that implement the invention or its features may have different names, divisions and/or formats. Furthermore, as will be apparent to one of ordinary skill in the relevant art, the modules, features, attributes, methodologies, clients, servers and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. The clients and servers discussed herein can each be implemented on a single computing device or on multiple computing devices as desired. Wherever functionality is described as being performed by a client or by a server, it is to be understood that the functionality can be provided by one or more components, and that these components can have other names as desired. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

1. A computer implemented server method for dynamically managing a user software license, the method comprising:
receiving at least one request from a client to access at least one feature of a software program, each request including identification information concerning the user and a hardware configuration identifier concerning a computer associated with the user;
responsive to receiving a request, retrieving stored software license information concerning the user, the stored software license information corresponding to the received identification information and including a stored hardware configuration identifier concerning the computer associated with the user and a stored hardware configuration identifier modification date;
comparing the received hardware configuration identifier to the stored hardware configuration identifier, to determine whether the received hardware configuration identifier is acceptably similar to the stored hardware configuration identifier; and
returning software license information concerning the user to the client.

2. The server method of claim 1 further comprising:
responsive to the received hardware configuration identifier being acceptably similar but not identical to the stored hardware configuration identifier, comparing the stored hardware configuration identifier modification date with a current date.

3. The server method of claim 2 further comprising:
responsive to the current date being sufficiently later than the stored hardware configuration identifier modification date:
updating the stored software license information concerning the user by replacing the stored hardware configuration identifier with the received hardware configuration identifier;
updating the stored software license information concerning the user by replacing the stored hardware configuration identifier modification date with the current date; and
returning software license information concerning the user indicating that the user is licensed to run the software, the software license information including the received hardware configuration identifier and current date.

4. The server method of claim 2 further comprising:
responsive to the current date not being sufficiently later than the stored hardware configuration identifier modification date:
determining that the user is not licensed to run the software program; and wherein
returning software license information concerning the user to the client comprises returning software license information indicating that the user is not licensed to run the software.

5. The server method of claim 1 further comprising:
responsive to the received hardware configuration identifier being identical to the stored hardware configuration identifier, returning software license information concerning the user to the client indicating that the user is licensed to run the software.

6. The server method of claim 1 further comprising:
responsive to the received hardware configuration identifier not being acceptably similar to the stored hardware configuration identifier and not being identical to the stored hardware configuration identifier:
determining that the user is not licensed to run the software program; and wherein
returning software license information concerning the user to the client comprises returning software license information indicating that the user is not licensed to run the software.

7. A computer implemented client method for dynamically managing a user software license, the method comprising:
sending at least one request to a server to access at least one feature of a software program;
receiving software license information concerning the user from the server, the license information including a hardware configuration identifier of a computer associated with the user and a hardware configuration identifier modification date;
creating a current hardware configuration identifier of the computer associated with the user; and
comparing the current hardware configuration identifier to the received hardware configuration identifier.

8. The client method of claim 7 further comprising:
responsive to the current hardware configuration identifier being acceptably similar but not identical to the received hardware configuration identifier, comparing the received hardware configuration identifier modification date with a current date.

9. The client method of claim 8 further comprising:
responsive to the current date being sufficiently later than the received hardware configuration identifier modification date:
updating the received software license information concerning the user by replacing the received hardware configuration identifier with the current hardware configuration identifier;
updating the received software license information concerning the user by replacing the received hardware configuration identifier modification date with the current date;
storing the updated license information; and
allowing the user to run the software program.

10. The client method of claim 8 further comprising:
responsive to the current date not being sufficiently later than the received hardware configuration identifier modification date, terminating the software program, such that the user cannot run the software program.

11. The client method of claim 8 further comprising:
responsive to the current date not being sufficiently later than the received hardware configuration identifier modification date, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

12. The client method of claim 7 further comprising:
responsive to the current hardware configuration identifier being identical to the received hardware configuration identifier, allowing the user to run the software program.

13. The client method of claim 7 further comprising:
responsive to the current hardware configuration identifier not being acceptably similar to the received hardware configuration identifier and not being identical to the received hardware configuration identifier, terminating the software program, such that the user cannot run the software program.

14. The client method of claim 7 further comprising:
responsive to the current hardware configuration identifier not being acceptably similar to the received hardware configuration identifier and not being identical to the received hardware configuration identifier, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

15. A computer implemented client method for dynamically managing a user software license, the method comprising:
starting a software program;
creating a current hardware configuration identifier of the computer associated with the user;
retrieving stored software license information concerning user, the license information including a hardware configuration identifier of a computer associated with the user and a hardware configuration identifier modification date; and
comparing the current hardware configuration identifier to the stored hardware configuration identifier.

16. The client method of claim 15 further comprising:
responsive to the current hardware configuration identifier being acceptably similar but not identical to the stored hardware configuration identifier, comparing the stored hardware configuration identifier modification date with a current date.

17. The client method of claim 16 further comprising:
responsive to the current date being sufficiently later than the stored hardware configuration identifier modification date:
updating the stored software license information concerning the user by replacing the stored hardware configuration identifier with the current hardware configuration identifier;
updating the stored software license information concerning the user by replacing the stored hardware configuration identifier modification date with the current date; and
allowing the user to run the software program.

18. The client method of claim 16 further comprising:
responsive to the current date not being sufficiently later than the stored hardware configuration identifier modification date, terminating the software program, such that the user cannot run the software program.

19. The client method of claim 16 further comprising:
responsive to the current date not being sufficiently later than the stored hardware configuration identifier modification date, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

20. The client method of claim 15 further comprising:
responsive to the current hardware configuration identifier being identical to the stored hardware configuration identifier, allowing the user to run the software program.

21. The client method of claim 15 further comprising:
responsive to the current hardware configuration identifier not being acceptably similar to the stored hardware configuration identifier and not being identical to the stored hardware configuration identifier, terminating the software program, such that the user cannot run the software program.

22. The client method of claim 15 further comprising:
responsive to the current hardware configuration identifier not being acceptably similar to the stored hardware configuration identifier and not being identical to the stored hardware configuration identifier, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

23. The server method of claim 2 wherein the received hardware configuration identifier being acceptably similar to the stored hardware configuration identifier further comprises:
the received hardware configuration identifier representing at least sixty percent of a hardware profile represented by the stored hardware configuration identifier.

24. The server method of claim 6 wherein the received hardware configuration identifier being acceptably similar to the stored hardware configuration identifier further comprises:
the received hardware configuration identifier representing at least sixty percent of a hardware profile represented by the stored hardware configuration identifier.

25. The client method of claim 8 wherein the current hardware configuration identifier being acceptably similar to the received hardware configuration identifier further comprises:
the current hardware configuration identifier representing at least sixty percent of a hardware profile represented by the received hardware configuration identifier.

26. The client method of claim 13 wherein the current hardware configuration identifier being acceptably similar to the received hardware configuration identifier further comprises:
the current hardware configuration identifier representing at least sixty percent of a hardware profile represented by the received hardware configuration identifier.

27. The client method of claim 16 wherein the current hardware configuration identifier being acceptably similar to the stored hardware configuration identifier further comprises:
the current hardware configuration identifier representing at least sixty percent of a hardware profile represented by the stored hardware configuration identifier.

28. The client method of claim 21 wherein the current hardware configuration identifier being acceptably similar to the stored hardware configuration identifier further comprises:
the current hardware configuration identifier representing at least sixty percent of a hardware profile represented by the stored hardware configuration identifier.

29. A computer system for dynamically managing a user software license, the computer system comprising:
a software portion for receiving at least one request from a client to access at least one feature of a software program, each request including identification information concerning the user and a hardware configuration identifier concerning a computer associated with the user;
a software portion for, responsive to receiving a request, retrieving stored software license information concerning the user, the stored software license information corresponding to the received identification information and including a stored hardware configuration identifier concerning the computer associated with the user and a stored hardware configuration identifier modification date;
a software portion for comparing the received hardware configuration identifier to the stored hardware configuration identifier, to determine whether the received hardware configuration identifier is acceptably similar to the stored hardware configuration identifier; and
a software portion for returning software license information concerning the user to the client.

30. The computer system of claim 29 further comprising:
a software portion for, responsive to the received hardware configuration identifier being acceptably similar but not identical to the stored hardware configuration identifier, comparing the stored hardware configuration identifier modification date with a current date.

31. The computer system of claim 30 further comprising:
a software portion for, responsive to the current date being sufficiently later than the stored hardware configuration identifier modification date:
updating the stored software license information concerning the user by replacing the stored hardware configuration identifier with the received hardware configuration identifier;
updating the stored software license information concerning the user by replacing the stored hardware configuration identifier modification date with the current date; and
returning software license information concerning the user indicating that the user is licensed to run the software, the software license information including the received hardware configuration identifier and current date.

32. The computer system of claim 30 further comprising:
a software portion for, responsive to the current date not being sufficiently later than the stored hardware configuration identifier modification date:
determining that the user is not licensed to run the software program; and
returning software license information indicating that the user is not licensed to run the software to the client.

33. The computer system of claim 29 further comprising:
a software portion for, responsive to the received hardware configuration identifier being identical to the stored hardware configuration identifier, returning software license information concerning the user to the client indicating that the user is licensed to run the software.

34. The computer system of claim 29 further comprising:
a software portion for, responsive to the received hardware configuration identifier not being acceptably similar to the stored hardware configuration identifier and not being identical to the stored hardware configuration identifier:
determining that the user is not licensed to run the software program; and
returning software license information indicating that the user is not licensed to run the software to the client.

35. A computer program product for dynamically managing a user software license, the computer program product comprising:
program code for sending at least one request to a server to access at least one feature of a software program;
program code for receiving software license information concerning the user from the server, the license information including a hardware configuration identifier of a computer associated with the user and a hardware configuration identifier modification date;
program code for creating a current hardware configuration identifier of the computer associated with the user;
program code for comparing the current hardware configuration identifier to the received hardware configuration identifier; and
a computer readable medium on which the program codes are stored.

36. The computer program product of claim 35 further comprising:
program code for, responsive to the current hardware configuration identifier being acceptably similar but not identical to the received hardware configuration identifier, comparing the received hardware configuration identifier modification date with a current date.

37. The computer program product of claim 36 further comprising:
program code for, responsive to the current date being sufficiently later than the received hardware configuration identifier modification date:
updating the received software license information concerning the user by replacing the received hardware configuration identifier with the current hardware configuration identifier;
updating the received software license information concerning the user by replacing the received hardware configuration identifier modification date with the current date;
storing the updated license information; and
allowing the user to run the software program.

38. The computer program product of claim 36 further comprising:
program code for, responsive to the current date not being sufficiently later than the received hardware configuration identifier modification date, terminating the software program, such that the user cannot run the software program.

39. The computer program product of claim 36 further comprising:
program code for, responsive to the current date not being sufficiently later than the received hardware configuration identifier modification date, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

40. The computer program product of claim 35 further comprising:
program code for, responsive to the current hardware configuration identifier being identical to the received hardware configuration identifier, allowing the user to run the software program.

41. The computer program product of claim 35 further comprising:
program code for, responsive to the current hardware configuration identifier not being acceptably similar to the received hardware configuration identifier and not being identical to the received hardware configuration identifier, terminating the software program, such that the user cannot run the software program.

42. The computer program product of claim 35 further comprising:
program code for, responsive to the current hardware configuration identifier not being acceptably similar to the received hardware configuration identifier and not being identical to the received hardware configuration identifier, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

43. A computer program product for dynamically managing a user software license, the computer program product comprising:
program code for starting a software program;
program code for creating a current hardware configuration identifier of the computer associated with the user;
program code for retrieving stored software license information concerning user, the license information including a hardware configuration identifier of a computer associated with the user and a hardware configuration identifier modification date;
program code for comparing the current hardware configuration identifier to the stored hardware configuration identifier; and
a computer readable medium on which the program codes are stored.

44. The computer program product of claim 43 further comprising:
program code for, responsive to the current hardware configuration identifier being acceptably similar but not identical to the stored hardware configuration identifier, comparing the stored hardware configuration identifier modification date with a current date.

45. The computer program product of claim 44 further comprising:
program code for, responsive to the current date being sufficiently later than the stored hardware configuration identifier modification date:
updating the stored software license information concerning the user by replacing the stored hardware configuration identifier with the current hardware configuration identifier;
updating the stored software license information concerning the user by replacing the stored hardware configuration identifier modification date with the current date; and
allowing the user to run the software program.

46. The computer program product of claim 44 further comprising:
program code for, responsive to the current date not being sufficiently later than the stored hardware configuration identifier modification date, terminating the software program, such that the user cannot run the software program.

47. The computer program product of claim 44 further comprising:
program code for, responsive to the current date not being sufficiently later than the stored hardware configuration identifier modification date, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

48. The computer program product of claim 43 further comprising:
program code for, responsive to the current hardware configuration identifier being identical to the stored hardware configuration identifier, allowing the user to run the software program.

49. The computer program product of claim 43 further comprising:
program code for, responsive to the current hardware configuration identifier not being acceptably similar to the stored hardware configuration identifier and not being identical to the stored hardware configuration identifier, terminating the software program, such that the user cannot run the software program.

50. The computer program product of claim 43 further comprising:
program code for, responsive to the current hardware configuration identifier not being acceptably similar to the stored hardware configuration identifier and not being identical to the stored hardware configuration identifier, performing at least one step from a group of steps comprising:
displaying a message to the user indicating that the user is not licensed to run the software program;
providing the user with an opportunity to purchase a license to run the software program;
allowing the user to run the software program without a license for a limited time only; and
allowing the user to run the software program without a license a limited number of times only.

51. The server method of claim 2 further comprising:
responsive to the current date not being sufficiently later than the stored hardware configuration identifier modification date, returning software license information concerning the user to the client indicating that the user is licensed to run the software.

52. The client method of claim 16 further comprising:
responsive to the current date not being sufficiently later than the stored hardware configuration identifier modification date, allowing the user to run the software program.

53. The computer system of claim 30 further comprising:
a software portion for, responsive to the current date not being sufficiently later than the stored hardware configuration identifier modification date, returning software license information concerning the user to the client indicating that the user is licensed to run the software.

54. The computer program product of claim 44 further comprising:
program code for, responsive to the current date not being sufficiently later than the stored hardware configuration identifier modification date, allowing the user to run the software program.
